(19) United States
(12) Patent Application Publication
(10) Pub. No.: US 2013/0173743 A1
(43) Pub. Date: Jul. 4, 2013

(54) MOBILE DEVICE DATA MANAGEMENT

(71) Applicants: DAVID M. GRIGG, Rock Hill, SC (US); JOHN FRANKLIN TUDERS, Charlotte, NC (US); PETER BERTANZETTI, Charlotte, NC (US)

(72) Inventors: DAVID M. GRIGG, Rock Hill, SC (US); JOHN FRANKLIN TUDERS, Charlotte, NC (US); PETER BERTANZETTI, Charlotte, NC (US)

(73) Assignee: BANK OF AMERICA CORPORATION, Charlotte, NC (US)

(21) Appl. No.: 13/342,080

(22) Filed: Jan. 1, 2012

(51) Int. Cl. G06F 15/16; G06F 7/00; H04W 4/02

(52) U.S. Cl. 709/217; 455/414.1; 707/812; 707/E17.044

(57) ABSTRACT

Embodiments of the invention include systems, methods, and computer-program products that assist a user in managing data on a mobile device. In one embodiment of the invention, the computer-implemented method receives data associated with a mobile device and stores the data in a database. The computer-implemented method then periodically updates the data in the database until the user desires to load the data onto the mobile device or onto a new mobile device. At the user's request, the computer-implemented method loads the data onto the mobile device. In some embodiments, the computer-implemented method determines the operating system of the mobile device and assists the user in conveniently transferring data from one mobile device to another mobile device. In further embodiments, the computer-implemented method augments the data with publicly or privately available information.

### BACKGROUND

Currently, customers use mobile devices to keep track of and manage many areas of their life. Mobile devices can be used as audio players, information sources, communication devices, calendars, and mobile wallets. Many customers come to rely on their mobile devices to manage their busy and complicated lives. Additionally, mobile devices often include sensitive or confidential information. Customers want this information available but are also concerned that the loss of the mobile device will cause the information to be lost. When a customer loses their mobile device, the efficiency driven by the customized data and settings on the customer's mobile device is lost. Restoring the mobile device to the previous settings is confusing, difficult, and time-consuming.

Customers also often use the same mobile devices for various aspects of their lives. For example, a customer may have a mobile device that is used for both business and personal use. Managing the contacts, files, and applications that are appropriate for one aspect of a customer's life may make it more difficult to manage the settings and files that are appropriate for another aspect of the customer's life. Customers may have to search through long lists of business contacts to find a personal contact that the customer wishes to get in touch with. Additionally, customers may wish that their mobile device is configured differently for different situations. For example, when a customer is traveling the customer may desire a different set of applications (e.g., currency calculators or foreign language dictionaries, etc.), a different security level, and different mobile wallet applications, than when the customer is going about their everyday life.

Therefore, a need exists for a computer-implemented method and system that can manage data on a customer's mobile device, including restoring data on a new device after losing a previous mobile device and establishing mobile device profiles for different situations.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Some embodiments of the present invention provide a computer-implemented method for managing data on a mobile device that involves receiving data from a user, wherein the data is associated with a mobile device, receiving a request from the user to communicate the data to a mobile device, identifying the data associated with the user, and communicating the data to the mobile device. In some embodiments, the data includes settings and files for the mobile device. In further embodiments, the computer-implemented method determines the operating system of the mobile device and modifies the data to load onto the operating system of the mobile device. In still further embodiments, the data is augmented before it is communicated to the mobile device. For example, the computer-implemented method may provide coupons, discounts, or suggestions to the user based on the data received from the user. Certain embodiments will feature the additional steps of establishing profiles for users such that the user can quickly and easily change the settings and files on the user's mobile device to be appropriate for different situations.

Embodiments of the present invention provide a system for managing data on a mobile device. In an embodiment of the invention, the system includes a computing platform including a processor and a memory. The system also includes a data routine stored in the memory and executable by the processor. The data routine is configured to receive data from the user, wherein the data is associated with a mobile device. The system further includes a financial institution database stored in the memory and configured to store data associated with the mobile device. The system further includes an identification routine stored in the memory and executable by the processor. The identification routine is configured to identify the data associated with the user. In some embodiments, the user's identity is also authenticated. Further, the system includes a communication routine stored in the memory and executable by the processor. The communication routine is configured to communicate the data to the mobile device is response to the user's request.

Embodiments of the present invention further provide a computer program product comprising a non-transitory computer readable medium having computer executable program code embodied therein for managing data on a mobile device. In one embodiment, the computer-readable medium includes: a first set of codes for causing a computer to receive data from a user, wherein the data is associated with a mobile device; a second set of codes for causing the computer to receive a request from the user to communicate the data to a mobile device; a third set of codes for causing the computer to identify the data associated with the user; and a fourth set of codes for causing the computer to communicate the data to the mobile device.

Other aspects and features, as recited by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, wherein:

FIG. 1 is a flow chart of a method for managing data on mobile devices, in accordance with some embodiments of the invention;

FIG. 2 is a depiction of an environment in which data associated with mobile devices is managed, in accordance with some embodiments of the invention;

FIG. 3 provides a block diagram of a financial institution database, in accordance with some embodiments of the invention;

FIG. 4 provides a block diagram illustrating the user's mobile device of FIG. 3 in accordance with an embodiment of the invention;

FIG. 5 provides a block diagram of a financial institution's banking system, in accordance with some embodiments of the invention;

FIGS. 6a and 6b provides flow charts of a computer-implemented method for managing data on mobile devices, in accordance with some embodiments of the invention; and

FIG. 7 provides an example of a mobile device loading data using a computer-implemented method, in accordance with some embodiments of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

An individual's mobile devices have become more than just communication devices. Mobile devices may store contact information for the individual's family, friends and business associates. Mobile devices store photographs, audio files, and videos. Memos and documents may be stored on the mobile device. Mobile devices may also store confidential financial information, such as that associated with a mobile wallet. Account numbers, passwords, transaction data, addresses and contact information may also be present on a mobile device. An individual who loses their mobile device may not know how to reload all of the sensitive and valuable information on the mobile device. Thus, there is a need for a computer-implemented method and system for loading data onto mobile devices.

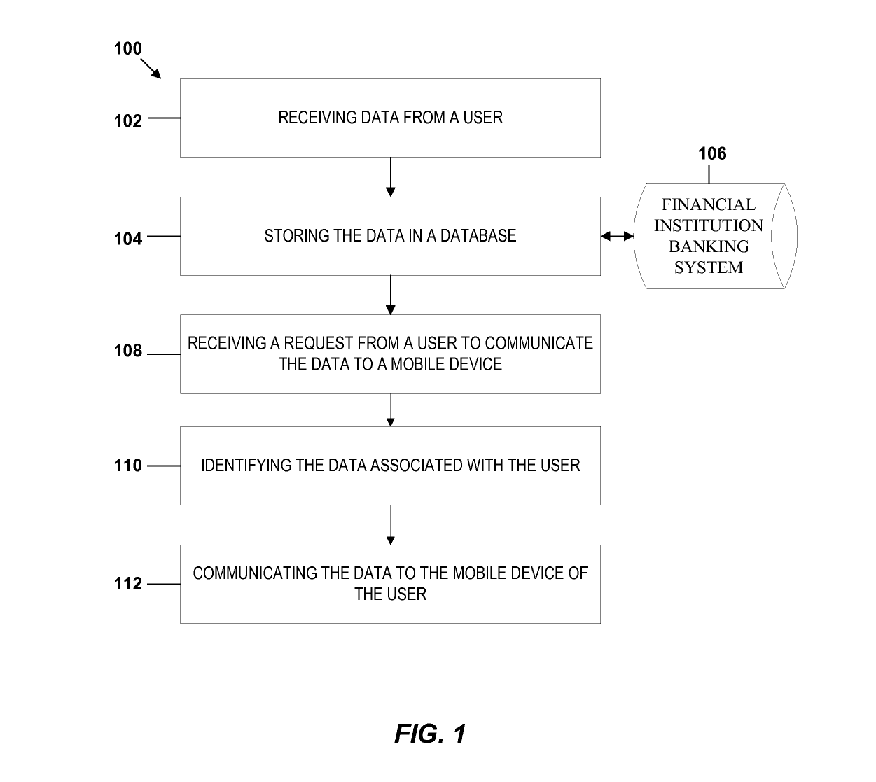

As illustrated in FIGS. 1-7, aspects of the present disclosure include methods, systems, and computer program products directed to a computer-implemented method and system of communicating data to a mobile device, wherein the data provides settings and files related to the user's mobile device. In an exemplary embodiment, a server receives data from the user, stores the data in a database, and communicates the data to a mobile device of the user at the user's request. In further embodiments, the data is periodically updated on the server so that changes to the user's settings and files are stored on the server. In a still further embodiment, the computer-implemented method augments the data when loading the data onto the user's mobile device. For example, the computer-implemented method and system may determine the operating system of the mobile device and modify the data so that the data is available across multiple platforms. It will be appreciated that, although embodiments of the present invention are generally described herein in the context of data for mobile communication devices, other embodiments of the invention may be adapted to provide data to other types of mobile devices and operating systems.

In an embodiment, the computer-implemented method allows a user to load data onto a new mobile device after losing a first mobile device. The user enrolls in the lost mobile device data recovery system and the user's mobile device data is uploaded to a remote site, such as a server associated with a financial institution. The user continues to use the mobile device and, in some embodiments, the data on the server is periodically updated. For example, the data may be updated on a regular interval or at the request of the user or financial institution. Thus, if the user adds new data to the mobile device, such as new financial accounts, files, or multimedia, the new data is stored on the server. If the user loses the mobile device and desires to restore the data from the mobile device onto a new mobile device, the user can alert the financial institution and initiate the computer-implemented method of restoring the user's data to the new mobile device. In an embodiment, the financial institution receives the request from the user, authenticates the user's identity, identifies the user's data, and communicates the data to the new mobile device of the user. In some embodiments, the financial institution augments the data for the user. For example, the financial institution may modify the user's data for a new operating system on a different type of mobile device or the financial institution may provide coupons for goods and services that the user's data indicates the user may be interested in receiving.

In another embodiment, the computer-implemented method allows a user to create profiles for use on mobile devices. As used herein, a profile is a series of settings and data for a mobile device. For example, a profile may be the user's contacts, the user's documents, the user's mobile wallet application, and the user's multimedia files. In some embodiments, a user may have a mobile device profile for business, a mobile device profile or personal use, and a mobile device profile for travel. The business profile may include business contacts and a mobile wallet preloaded with the user's business accounts. The travel profile may have higher security, applications that are appropriate for travel (e.g., currency calculators, foreign language dictionaries, etc.), and pre-loaded maps. In some embodiments, the user is able to select a profile to load onto a mobile device as needed. For example, if the user uses the same mobile device for work and personal use, the user may load the work profile onto the mobile device during the work week and load the personal profile onto the mobile device during the weekend. In some embodiments, the data is periodically updated on the profile that is currently in use. Similarly, if a user travels to another country and purchases a mobile device in that country, the user could upload to the travel profile to the new device and have convenient access to the user's personal data and settings.

In a still further embodiment, the computer-implemented method allows multiple users to use the same mobile device. Each user may have a personal profile that can be loaded onto a mobile device at the user's request. For example, two users may share a mobile device, such as a tablet computer. The users may have separate settings, data, and accounts that they desire on the mobile device. By using the computer-implemented method, the users are able to securely and remotely store their personal data and settings for the mobile device while also updating and loading the personal data onto the mobile device at the user's request.

FIG. 1 illustrates a general process flow of a computer-implemented method 100 for managing data on a mobile device in accordance with an embodiment of the invention. In block 102, the computer-implemented method receives data from the user, wherein the data includes settings and/or files associated with a mobile device. In an embodiment, the computer-implemented method receives the data over a network, such as a wireless network. The data may be encrypted for security. In some embodiments, the data include mobile device settings and files, such as contact lists, mobile wallet details, applications, multimedia, documents, and calendar files.

The mobile device of the invention is broadly construed to include a variety of personal devices that a user may user. For example, the mobile device may include a device for conducting transactions at an ATM, a personal identification number (PIN) payment device, a contactless payment device (e.g., a key fob), a radio frequency identification device (RFID) and the like, a computer, (e.g., a personal computer, tablet computer, desktop computer, server, laptop, etc.), an electronic mobile device (e.g., a smart phone, cellular phone, personal digital assistant (PDA) device, MP3 device, personal GPS device, etc.), a gaming device (e.g., Nintendo Wii®, PlayStation Portable®, etc.), and/or various combinations of the foregoing.

In block 104, the computer-implemented method stores the data in a database. In an embodiment, the database is a financial institution database 106. The data may be stored in the database initially and then periodically updated by the computer-implemented method. For example, the data may be stored in the database when the user initially enrolls in a mobile device data management system and then updated at the request of the user, the request of the financial institution, or based on the mobile device. When the data is stored in the database, the computer-implemented method may augment the data with additional publicly or privately available data. For example, the computer-implemented method may augment the user's contact list with images and additional contact information based on data available to the bank and based on social network data. In some embodiments, the computer-implemented method also provides coupons, discounts, or suggestions to the user based on the data stored in the database.

In block 108, the computer-implemented method 100 receives a request from the user to communicate the data to the mobile device. The user may make the request through a mobile device or through a computing device. For example, the user may install an application on a mobile device and request data be communicated to the mobile device using the application. In another embodiment, the user requests that data be communicated to a mobile device by using a computing device such as a personal computer or an ATM. The user may request that data be loaded onto a new mobile device, such as when the user loses an older mobile device and desires assistance in setting up a new mobile device, or the user may request that data be loaded onto an existing mobile device. For example, the user may set up various profiles that comprise related settings and data. A user may have a business profile and a personal profile, wherein the business profile includes the user's business contacts and files and the personal profile includes the user's personal contacts and files. The user may request that the data be communicated to the mobile device in a variety of ways, such as by texting a contact number associated with the computer-implemented method, and the aforementioned descriptions of applications and computing devices do not limit the method.

Turning now to block 110, the computer-implemented method 100 identifies the data associated with the user. In an exemplary embodiment of the invention, the computer-implemented method identifies the user making the request and then locates the user's data in the financial institution database. In an embodiment, the computer-implemented method also authenticates the user's identity. For example, the computer-implemented method may prompt the user to enter a password or conduct a biometric screen to authenticate the user's identity. In some embodiments, the computer-implemented method identifies the profile selected by the user; in further embodiments, the computer-implemented method identifies the default settings and data provided by the user for all mobile devices.

In block 112, once the computer-implemented method 100 identifies the data associated with the user, the computer-implemented method communicates the data to the mobile device of the user. The data may be communicated to the mobile device wirelessly over the network or through a wired connection. The data may be communicated to the mobile device in a compressed and/or encrypted format. In an exemplary embodiment, the computer-implemented method determines the operating system of the mobile device and modifies the data and settings to establish the user's preferences on the new mobile device even if the data was loaded onto the server from a different operating system. For example, if the user previously used an I-Phone™ but switched to a Blackberry™ device, the computer-implemented method may be able to take the settings and data stored for the I-Phone™ and modify the data for setup on the Blackberry™ device.

As will be discussed, the computer-implemented method may have a variety of supplemental steps and accomplish the steps in a variety of ways. Further, the steps do not need to be performed in the order discussed herein. The examples disclosed herein are not intended to be limiting to the various ways in which the data is received from the user, the request is received from the user, or the data is communicated to the mobile device.

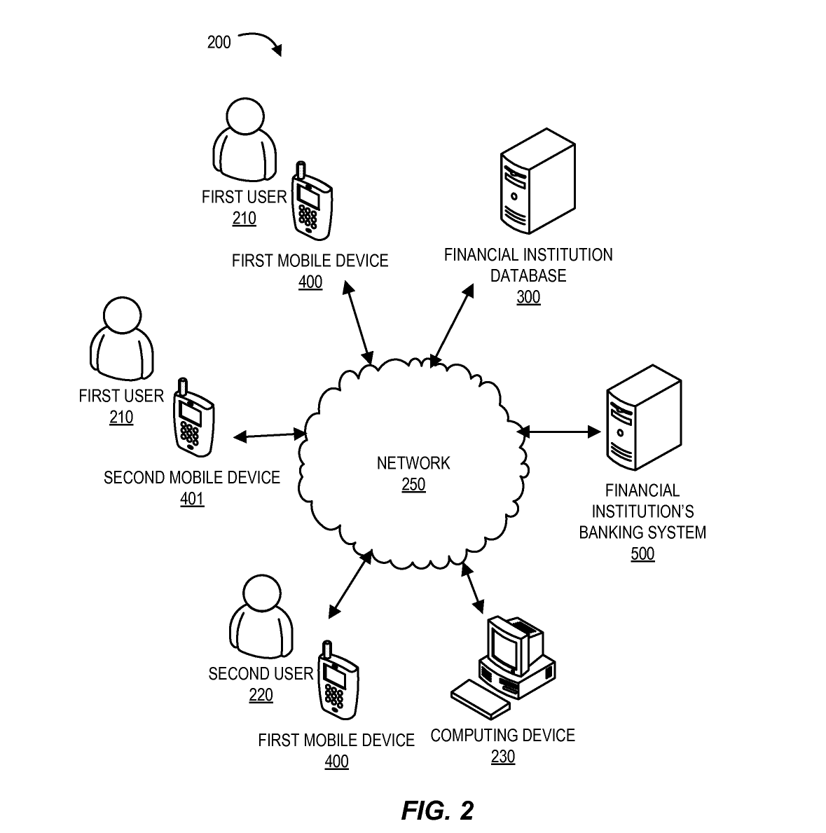

Referring to FIG. 2, a block diagram illustrating an environment 200 in which a user 210 manages data on a mobile device 400 is provided in accordance with an embodiment of the invention. The user manages the data on the mobile device 400 or on a second mobile device 401 using the financial institution database 300 and the financial institution banking system 500. The environment 200 may also include a computing device 230, such as a personal computer or ATM, which allows a user to control the computer-implemented method. For example, the user 210 may load files and settings onto the user's account in the financial institution database 300 for storage on a mobile device via the computing device. The user 210 may also use the computing device 230 to instruct the computer-implemented method to upload data from the financial institution database 300 to the user's mobile device 400 or to the second mobile device 401. In this manner, the user 210 is able to recover data on the user's first mobile device 400 and load the data onto the user's second mobile device 401. In a further embodiment, a second user 220 may load data or profiles onto a mobile device 400 using the computer-implemented method.

When the user enrolls in the system, the computing device 230 or the user's mobile device 204 transmits data to the financial institution's database 300. In an embodiment, the computing device 230 or the user's mobile device 204 transmits the data over a network 250. For example, the data may be transmitted over wired networks, wireless networks, 3G or 4G phone networks, other types of phone networks, the Internet, Near Field Communication (NFC) networks, Bluetooth™ networks, or the like.

In the environment 200, the mobile device 400 communicates with the financial institution database 300. In one embodiment, the mobile device 400 communicates settings and files to the financial institution database 300. The mobile device 400 may communicate the data initially and then periodically after the initial transfer. The data transmit over the network 250 to the financial institution database 300, where the identity of the user 210 and the settings and files associated with the user's mobile device 204 are stored. The financial institution database 300 may be integral with the financial institution's banking system 500 or may be operated separately from the financial institution's banking system 500.

When the first user 210 or the second user 220 desires to recover data onto a mobile device or load a profile into a mobile device, the user communicates with the financial institution banking system 500. In some embodiments, the user communicates with the financial institution banking system 500 through the first mobile device 400 or second mobile device 401. In another embodiment, the user communicates with the financial institution banking system 500 through the computing device 230. The banking system 500 then confirms the identity of the user and cooperates with the financial institution database 300 to transfer the data to the user's mobile device 400 or 401.

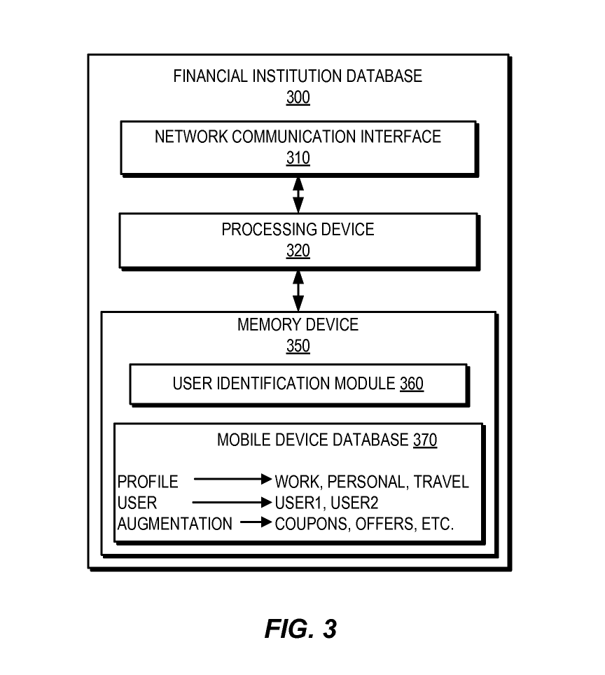

Turning now to FIG. 3, a block diagram illustrating a financial institution database 300 is provided, in accordance with an embodiment of the invention. In one embodiment of the invention, the financial institution database 300 is operated by a second entity that is a different or separate entity from the first entity (e.g., the financial institution) that, in one embodiment of the invention, implements the banking system 500. In one embodiment, the financial institution database 300 could be part of the banking system 500. As illustrated in FIG. 3, the financial institution database 300 generally includes, but is not limited to, a network communication interface 310, a processing device 320, and a memory device 350. The processing device 320 is operatively coupled to the network communication interface 310 and the memory device 350. In one embodiment of the financial institution database 300, the memory device 350 stores, but is not limited to, an operating system determination module 360 and a mobile device database 370. The mobile device database 370 stores data including, but not limited to, mobile device settings, mobile device files such as contacts, pictures, videos, documents, applications, etc. In one embodiment of the invention, both the operating system determination module 360 and the mobile device database 370 may associate with applications having computer-executable program code that instructs the processing device 320 to operate the network communication interface 310 to perform certain communication functions involving the mobile device database 370 described herein. In one embodiment, the computer-executable program code of an application associated with the mobile device database 370 may also instruct the processing device 320 to perform certain logic, data processing, and data storing functions of the application associated with the mobile device database 370 described herein.

The network communication interface 310 is a communication interface having one or more communication devices configured to communicate with one or more other devices on the network 250. The processing device 320 is configured to use the network communication interface 310 to receive information from and/or provide information and commands to a mobile device 204, other financial institution banking systems, the financial institution database 300, the banking system 500, and/or other devices via the network 250. In some embodiments, the processing device 320 also uses the network communication interface 310 to access other devices on the network 250, such as one or more web servers of one or more third-party data providers. In some embodiments, one or more of the devices described herein may be operated by a second entity so that the third-party controls the various functions involving the financial institution database 300. For example, in one embodiment of the invention, although the banking system 500 is operated by a first entity (e.g., a financial institution), a second entity operates the financial institution database 300 that stores the mobile device information and determines the identity of the user, the operating system of the mobile device, and any augmentation of the data.

As described above, the processing device 320 is configured to use the network communication interface 310 to gather data from the various data sources. The processing device 320 stores the data that it receives in the memory device 350. In this regard, in one embodiment of the invention, the memory device 350 includes datastores that include, for example: (1) authentication information for users; (3) information regarding the user's mobile device settings and files; and/or (4) different mobile device profiles for users. In an embodiment, the datastores may be added to independently of the banking system 500. For example, businesses wanting to attract customers may provide offers associated with the user's settings and files, which then updates and augments the data in the memory device 350.

In some embodiments of the invention, the financial institution database 300 is configured to be controlled and managed by one or more third-party data providers (not shown in FIG. 2) over the network 250. In other embodiments, the financial institution database 300 is configured to be controlled and managed over the network 250 by the same entity that maintains the financial institution's banking system. In other embodiments, the financial institution database 300 is configured to be controlled and managed over the network 250 by the financial institution managing the computer-implemented method. In still other embodiments, the financial institution database 300 is a part of the banking system 500.

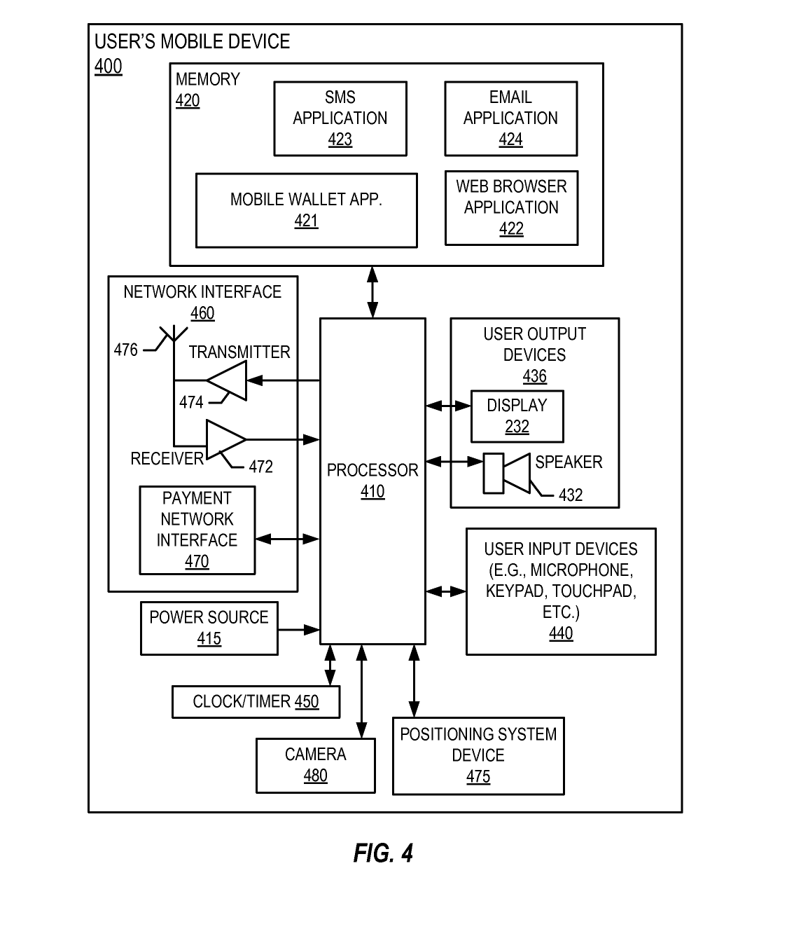

FIG. 4 provides a block diagram illustrating the mobile device 400 of FIG. 2 in more detail, in accordance with embodiments of the invention. In one embodiment of the invention, the mobile device 400 is a mobile telephone. However, it should be understood, however, that a mobile telephone is merely illustrative of one type of mobile device 400 that may benefit from, employ, or otherwise be involved with embodiments of the present invention and, therefore, should not be taken to limit the scope of embodiments of the present invention. Other types of mobile devices 400 may include portable digital assistants (PDAs), pagers, mobile televisions, gaming devices, laptop computers, cameras, video recorders, audio/video player, radio, GPS devices, or any combination of the aforementioned.

The mobile device 400 generally includes a processor 410 communicably coupled to such devices as a memory 420, user output devices 436, user input devices 440, a network interface 460, a power source 415, a clock or other timer 450, a camera 480, and a positioning system device 475. In an embodiment, the network interface 460 includes a Near Field Communication device capable of communicating with other NFC enabled devices. The processor 410 and other processors described herein generally include circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 250. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless telephone network 352. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN), Bluetooth™ network, or other communication/data networks.

The network interface 460 may also include a payment network interface 470. The payment network interface 470 may include software, such as encryption software, and hardware, such as a modem, for communicating information to and/or from one or more devices on the network 250. For example, the mobile device 400 may be configured so that it can be used as a credit or debit card by, for example, wirelessly communicating account numbers or other authentication information to a terminal of the network 250.

As described above, the mobile device 400 has a user interface that is, like other user interfaces described herein, made up of user output devices 436 and/or user input devices 440. The user output devices 436 include a display 232 (e.g., a liquid crystal display or the like) and a speaker 432 or other audio device, which are operatively coupled to the processor 410. The user input devices 440, which allow the mobile device 400 to receive data from a user such as the user, may include any of a number of devices allowing the mobile device 400 to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile device 400 may also include the positioning system device 475 that is configured to be used by a positioning system to determine a location of the mobile device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 400. In other embodiments, the positioning system device 475 includes a proximity sensor or transmitter, such as an RFID tag, that can sense or be sensed by devices known to be located proximate a merchant or other location to determine that the consumer mobile device 400 is located proximate these known devices.

The mobile device 400 further includes a power source 415, such as a battery, for powering various circuits and other devices that are used to operate the mobile device 400. Embodiments of the mobile device 400 may also include a clock or other timer 450 configured to determine and, in some cases, communicate actual or relative time to the processor 410 or one or more other devices.

The mobile device 400 also includes the memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the mobile device 400 described herein. For example, the memory 420 may include such applications as a conventional web browser application 422 and/or a mobile wallet application 421. These applications also typically provide a graphical user interface (GUI) on the display 232 that allows the user to communicate with the consumer mobile device 400, the banking system 500, and/or other devices or systems. In one embodiment of the invention, when the user decides to enroll in the mobile banking program, the user downloads or otherwise obtains the mobile banking system client application from the banking system 500 or from a distinct application server. In other embodiments of the invention, the user interacts with the banking system 500 via the web browser application 422 in addition to, or instead of, the mobile wallet application 421.

The memory 420 can also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information, etc.

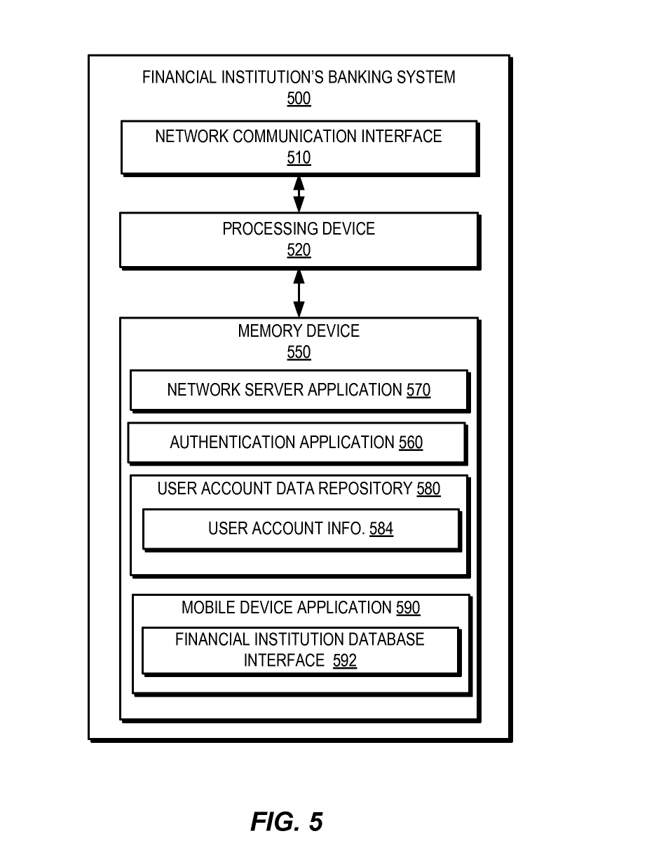

FIG. 5 provides a block diagram illustrating the banking system 500 in greater detail, in accordance with embodiments of the invention. As illustrated in FIG. 5, in one embodiment of the invention, the banking system 500 includes a processing device 520 operatively coupled to a network communication interface 510 and a memory device 550. In certain embodiments, the banking system 500 is operated by a first entity, such as a financial institution, while in other embodiments the banking system 500 is operated by an entity other than a financial institution.

It should be understood that the memory device 550 may include one or more databases or other data structures/repositories. The memory device 550 also includes computer-executable program code that instructs the processing device 520 to operate the network communication interface 510 to perform certain communication functions of the banking system 500 described herein. For example, in one embodiment of the banking system 500, the memory device 550 includes, but is not limited to, a network server application 570, an authentication application 560, a user account data repository 580, which includes user account information 584, a mobile device application 590, which includes a financial institution database interface 592 configured to communicate with the financial institution database 300, and other computer-executable instructions or other data. The computer-executable program code of the network server application 570, the authentication application 560, or the mobile device application 590 may instruct the processing device 520 to perform certain logic, data-processing, and data-storing functions of the banking system 500 described herein, as well as communication functions of the banking system 500.

As used herein, a “communication interface” generally includes a modem, server, transceiver, and/or other device for communicating with other devices on a network, and/or a user interface for communicating with one or more users. Referring again to FIG. 2, the network communication interface 510 is a communication interface having one or more communication devices configured to communicate with one or more other devices on the network 250, such as the mobile device 400, the banking system 500, the computing device 230, and the financial institution database 300. The processing device 520 is configured to use the network communication interface 510 to transmit and/or receive data and/or commands to and/or from the other devices connected to the network 250.

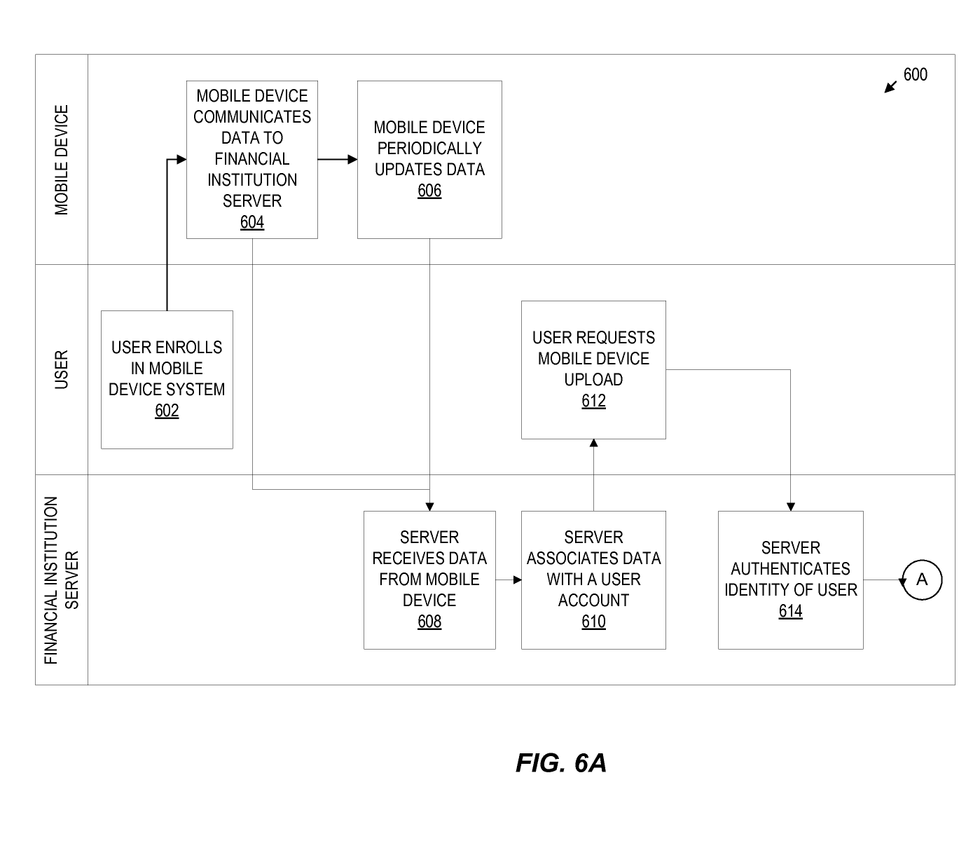

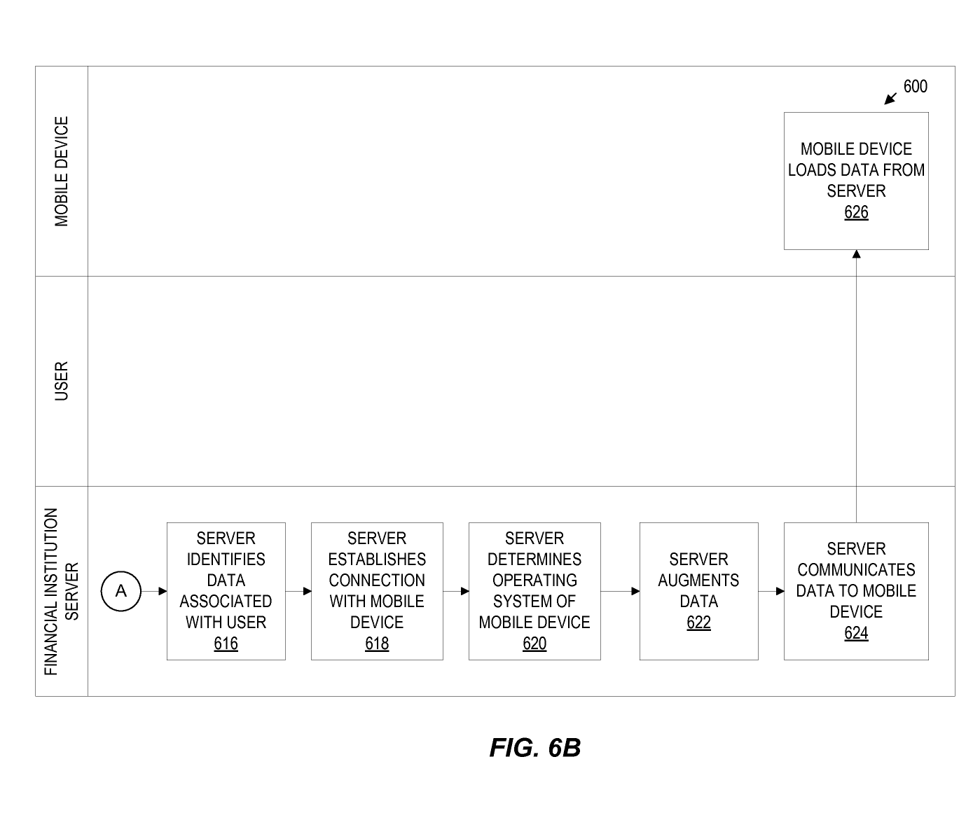

FIGS. 6A and 6B provide a modified flow chart 600 showing actions taken by the user, the mobile device, and the financial institution server to manage data and profiles associated with mobile device data. While the steps are depicted as performed by one of the parties listed in the flow chart, the steps do not need to be performed by that exact party. For example, the user is depicted as requesting a mobile device upload, such as a profile request, to the server in block 612; however, the mobile device may do this automatically instead of or in addition to the user. The mobile device may determine the day of the week or the location of the user and request a profile based on these determinations.

In block 602, the user enrolls in the mobile device system. In an embodiment, a user enrolls a mobile device in a system operated in association with a financial institution. In some embodiments, when the user enrolls in the system the user provides authentication information for the user's identity, contact information, information for syncing or connecting to the user's mobile device, and other settings or data associated with the mobile device or user accounts. The user may provide this information via the mobile device or via a computing device, such as a personal computer or bank-associated computing device (e.g., an ATM, a terminal in a bank office, etc.). The user may also initiate a data upload from the mobile device to the server when enrolling in the mobile device system. In this manner, the user establishes a baseline from which the mobile device data can be amended. In an embodiment, the baseline is saved so that the user can return to the baseline settings and data on the mobile device at the user's request. In a further embodiment, the user establishes profiles, such as business, personal, or travel, for the mobile device so that the user can have a profile of settings and data for the mobile device that can be selected at will be the user. It should be understood that the named profiles are not the only types of profiles that are possible. A user could establish a shopping profile, a profile for another individual (e.g., a child, etc.), or a high security profile, etc.

In some embodiments, the profiles are established based on use of the mobile device during specific time periods. For example, the computer-implemented method can automatically establish profiles based on the user's use of the mobile device during specific time periods. The user can instruct the method to include in a work profile all settings and files modified during the work week. In another example, the user can instruct the method to include in a personal profile all settings and files modified during the weekend. It should be understood that the time periods can be determined by the user. For example, the user can indicate to the computer-implemented method that the user is traveling during a week and therefore the contacts, applications, and files used during that week will be included in a travel profile for the user. The user is able to turn profile recording on and off at will such that the user can exclude activity from profiles at the user's preference.

In block 604, the mobile device communicates data to the financial institution server. The mobile device may communicate the data to the financial institution server wirelessly or over a wired connection. The mobile device may transfer settings, such as preferences, defaults, options, etc. For example, the mobile device may transfer settings that include how the user's email is displayed on the mobile device, the password to access the mobile device, and the ring tones for various individuals in the contacts. Similarly, the settings may relate to the mobile wallet application of the user so that default settings and options, such as when authorization of a transaction is required or from which account a purchase will be made, will be communicated to the server. The mobile device may also transfer files, such as contact lists, account or transaction files, multimedia files (e.g., images, audio files, video files, etc.), documents, calendars, records, etc.

In block 606, in some embodiments the mobile device periodically updates data on the server. For example, the mobile device may automatically update the server on a regular interval. In another embodiment, the mobile device updates data on the server based on the mobile device, such as when the mobile device determines that a threshold level of change in settings or data has occurred. For example, if a significant setting is changed or a predetermined amount of data has changed on the mobile device, such as when a large file is loaded onto the mobile device, the mobile device may determine that a significant change to the settings and data on the mobile device has occurred and trigger an upload of data to the server. In another embodiment, the mobile device updates data on the server at the request of the user. In a still further embodiment, the mobile device updates data to the server based on the environment. For example, the mobile device may update data on the server whenever the mobile device is connected to the network via a high speed connection, such as a Wi-Fi connection or a wired connection.

When the mobile device updates data on the server, the mobile device provides information that allows the server to associate the data with the user in the financial institution database. For example, the mobile device may provide information related to the user's name, contact information, or account number. In an embodiment, the information is provided in the form of an identifier for the mobile device, such as a phone number or identifier for a computing device. In a further embodiment, the mobile device provides information that allows the server to associate the data with a profile of the user in the financial institution database, such as a travel profile or a business profile for a user. If a profile is loaded on a mobile device, the mobile device will update changes to that profile when the data is uploaded to the server. Thus, if a user is using a mobile device with a personal profile on it and loads a new contact to the mobile device contact list, when the mobile device updates the data on the server the new contact will be saved with the personal profile.

Turning to block 608, the server receives the data the mobile device. In one embodiment, the server receives the data over the network 250. In some embodiments, the server decrypts the data into a format that the server is able to review. In an embodiment, the server receives the data from the mobile device and supplements the data with information from secondary sources. For example, the data may be supplemented with the time of the transaction, with the location of the transaction, with the method that the transaction is being conducted (e.g., credit card, mobile payment device, etc.), or with the category that the business where the transaction is occurring is within (e.g., a grocery store, a restaurant, a clothing store, etc.).

In block 610, the server associates the data with a user account or profile. In an embodiment, the server interacts with a financial institution banking system to look up the account number and identify the user name associated with the account number. In another embodiment, the server associates the mobile device number, such as the phone number or computing device identifier, with an account or profile in the financial institution database. In this manner, the data that is coming into the server can be used to update the appropriate account or profile on the server for when the user wants to reload the data onto a new or existing mobile device. As discussed, the server may associate the data with a user account or profile each time the data is updated to the server. The data may replace the existing data on the server or be saved as a new image of the mobile device settings and files. In an embodiment, the data is time stamped so that the user can re-establish the mobile device with the settings as they existed at that timestamp. In a further embodiment, the user has the option of replacing or creating a new image of the mobile device on the server.

In block 612, at some point after enrolling in the system, the user requests a mobile device upload. For example, the user may have lost their mobile device and purchased a new mobile device. The user would like to establish the settings and data on the new device conveniently and securely. In another example, the user may not like the current settings on a mobile device and instead the user desires to go back to an earlier setting on the mobile device. In a further embodiment, the user may desire to change the profile on the mobile device, such as switching from a personal profile to a business profile. The user may request the mobile device upload in a variety of ways. In an embodiment, the user requests the mobile device upload using the mobile device. For example, the user may install an application on the mobile device that allows the user to upload data or a profile to the mobile device. The user may also send a text message, messaging service message, phone call, instant message, or email from the mobile device to a contact associated with the financial institution. The financial institution receives this message and based on the message identifies the user's mobile device. In a further embodiment, the user request the mobile device upload using a computing device processor, such as a personal computer or ATM. The user may enter the mobile device identifier, such as the phone number, into a website portal.

In block 614, the server authenticates the identity of the user making the data upload request. In an embodiment, the server authenticates the identity of the user by prompting, receiving, and evaluating a password. For example, when the user requests a data upload the server may prompt the user to enter a password that confirms the user's identity. In another embodiment, the server authenticates the user's identity by use of biometric data, such as fingerprint scans, iris scans, or the like. In a still further embodiment, the server authenticates the user's identity by providing challenge questions, such as the user's mailing address, the user's last transaction, or other information available only to the financial institution and the user. In another embodiment, the user's identity is authenticated based on the location or method by which the user has requested the mobile device upload. For example, the user may have requested the mobile device upload using a mobile device that is registered with the financial institution. If the user only wants to change a profile on the mobile device, the computer-implemented method may not request further authentication of the user's identity. In another example, if the user requested the mobile device upload from a registered computing device, such as an ATM where the user authenticated the user's identity using a bankcard, the user may not be prompted to further authenticate their identity.

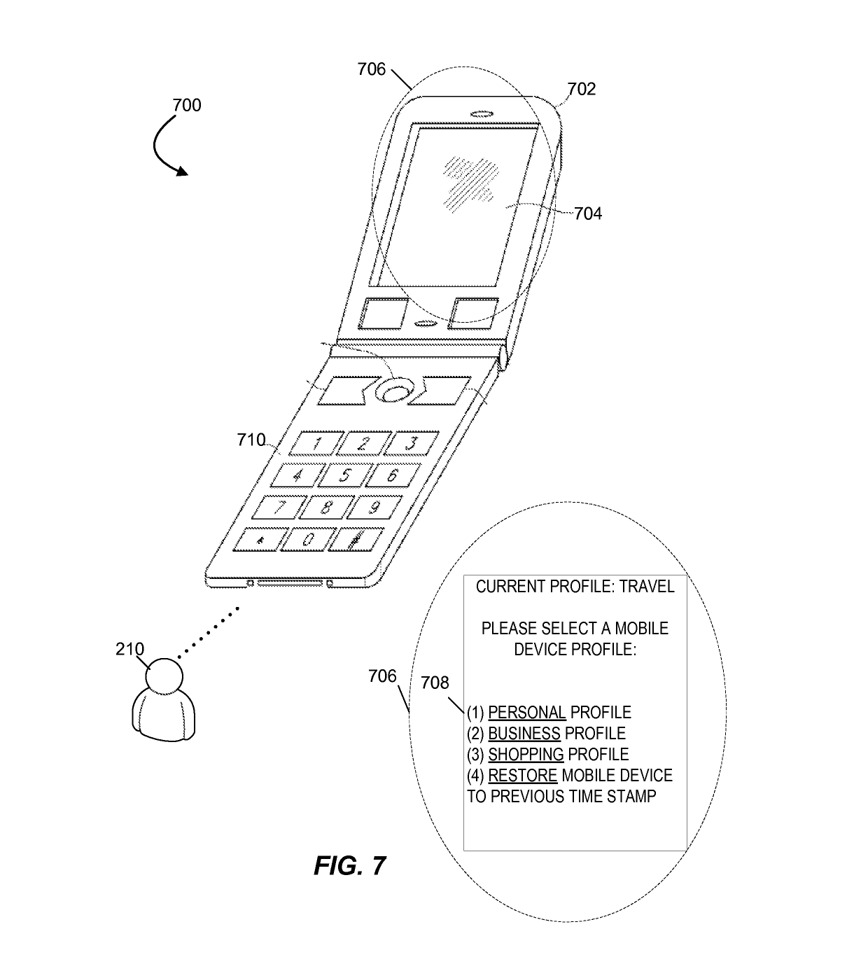

In block 616, after the user's identity is authenticated the server identifies data associated with the user. In an embodiment, the computer-implemented method searches the financial institution database for the user's data based on the user's identity. The user may have data stored in the financial institution database by the user's name, account number, or phone number. In another embodiment, the computer-implemented method identifies data associated with a profile of the user. The user may have multiple profiles associated with a single name. As will be discussed with respect to FIG. 7, the user may be given the option to select a specific profile for which the computer-implemented method will identify data.

In block 618, the server establishes a connection with the mobile device. The mobile device may establish an encrypted or secure connection so that the data being communicated between the mobile device and the server is not available to another party. In an embodiment, the server establishes the connection over the network.

In block 620, in some embodiments the server determines the operating system of the mobile device. In an embodiment, the server determines the operating system based on the connection formed between the mobile device and the server. For example, the mobile device may transfer the information related to the operating system to the server. The server determines the operating system of the mobile device so that the data is transmitted to the mobile device in the proper format for the operating system. For example, a user may have used a smart phone previously but may have switched to a PDA and desire to load the data and settings from the smart phone onto the PDA. The operating system may differ between the smart phone and the PDA. In an embodiment, the computer-implemented method recognizes the different operating system and modifies the data and settings so that the data is appropriate for the new device. Thus, the computer-implemented method assists users in transferring data and settings across platforms.

In block 622, in some embodiments the server augments the data that will be communicated to the mobile device. In an embodiment, the computer-implemented method customizes the data for the user. In one embodiment, the computer-implemented method supplements the data with user-specific data. For example, the computer-implemented method may supplement the data with user rewards for using a mobile wallet. If the data that is uploaded to the server indicates that the user is using a mobile wallet application, the user may receive coupons or discounts for the locations that the user typically shops at using the mobile wallet. The coupon or discount may be automatically loaded onto the mobile device when the user requests the update of the mobile device. The computer-implemented method may also provide suggestions to the user based on the data uploaded to the server. For example, the computer-implemented method may suggest new restaurants based on the transaction history of the user available in the mobile wallet data stored on the server.

The computer-implemented method may also augment the data with additionally available data, such as contact information for the user's contacts. For example, if the user has a list of contacts on a mobile device, wherein the list comprises the names and phone numbers of individuals, the computer-implemented method may augment that list with pictures, addresses, and email addresses of the individuals from available sources. The available sources may be social networking sites, data available to the financial institution, or other publicly or privately available information. Similarly, book reviews may be provided for audio books that are stored on the mobile device, album covers may be provided for songs that are stored on the mobile device, and maps may be preloaded for regions where the mobile device indicates in some manner (e.g., a calendar file, etc.) that the user is planning on visiting the region.

In block 624, the server communicates the data to the mobile device. In an embodiment, the server communicates the data wirelessly over the network to the mobile device. In another embodiment, the server communicates the data over a wire connection to the mobile device. In some embodiments, the server encrypts the data before communicating the data to the mobile device. The data may be communicated in a single file, such as a compressed file, or the data may be communicated via an updating process, wherein portions of the data are transferred with intermittent stops until all of the data is transferred. The updating process may assist users that are in regions of slow upload speed, where users desire to use high bandwidth applications on the mobile device during the upload process, or when the users are going in and out of network coverage.

In block 626, the mobile device loads the data from the server. In an embodiment, the mobile device receives the file from the server and loads the data so that the mobile device has the settings and data desired by the user. For example, the mobile device may load the data so that the desired profile is on the mobile device. The user's business accounts and contacts may have been deleted from the mobile device and replaced with the user's personal accounts and contacts if the user desired to load the personal profile. In another embodiment, the user's settings and data are automatically modified so that a new operating system includes the settings and data as used by the user on a previous operating system. The computer-implemented method assists users in transferring files and settings across operating systems.

After loading the data from the server onto the mobile device, the computer-implemented method continues to operate for the user. In block 626, the computer-implemented method is able to begin the process again by receiving data from the mobile device, saving the data to a financial institution database, and preparing to load the data onto the user's mobile device again.

In FIG. 7, an example 700 of loading a profile onto a mobile device is presented, in accordance with an embodiment of the invention. In this example, the user 210 activates an application on a mobile device 702, such as a cell phone, and navigates to a screen 704 providing the option to load a profile onto the mobile device. The screen may provide an indication of the current profile on the mobile device, such as that the “Travel” profile is loaded onto the mobile device. The screen may also provide options for loading different profiles 708 onto the mobile device, such as a “Personal” profile, a “Business” profile, or a “Shopping” profile, which are selectable by using the input mechanism 710, such as a keyboard, of the mobile device 702. In some embodiments, the computer-implemented method also provides the option to restore the mobile device to a previous time stamp, such as when the mobile device had a specific set of settings and data that the user preferred over the current settings. Advantageously, the application is able to immediately conveniently and automatically change settings and data on a mobile device for the user. In some embodiments, the user loads the application onto a new mobile device and is able to load any of the user's saved profiles onto the mobile device.

The above description refers to a centralized server as the computing device processor and describes the server as performing the computer-implemented method. It should be understood, however, that the computing device processor can be a computing device of the user and the processor associated with the computing device can perform the computer-implemented method. In one embodiment, the data processing associated with the computer-implemented method can be performed on the computing device. For example, the mobile device may communicate with the user's personal computer to receive data associated with the user's transaction history and offers and then perform the computer-implemented method based on the data received from the personal computer. In this example, the computer-implemented method is capable of operating when the user does not have access to wireless networks, such as in areas of low coverage or where buildings prevent coverage.

The flowcharts and block diagrams in the figures illustrate the architecture, functionality, and operation of possible implementations of apparatuses, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, functions repeated by the two blocks shown in succession may, in fact, be executed substantially concurrently, or the functions noted in the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer-executable instructions.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Embodiments of the present invention are described below with reference to flowchart illustrations and/or block diagrams of such methods and apparatuses. It will be understood that blocks of the flowchart illustrations and/or block diagrams, and/or combinations of blocks in the flowchart illustrations and/or block diagrams, can be implemented by computer-executable program instructions (i.e., computer-executable program code). These computer-executable program instructions may be provided to a processor of a general purpose computer, special purpose computer, or other programmable data processing apparatus to produce a particular machine, such that the instructions, which execute via the processor of the computer or other programmable data processing apparatus, create a mechanism for implementing the functions/acts specified in the flowchart and/or block diagram block or blocks. As used herein, a processor may be “configured to” perform a certain function in a variety of ways, including, for example, by having one or more general-purpose circuits perform the function by executing one or more computer-executable program instructions embodied in a computer-readable medium, and/or by having one or more application-specific circuits perform the function.

These computer-executable program instructions may be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

Any combination of one or more computer-readable media/medium may be utilized. In the context of this document, a computer-readable storage medium may be any medium that can contain or store data, such as a program for use by or in connection with an instruction execution system, apparatus, or device. The computer-readable medium may be a transitory computer-readable medium or a non-transitory computer-readable medium.

A transitory computer-readable medium may be, for example, but not limited to, a propagation signal capable of carrying or otherwise communicating data, such as computer-executable program instructions. For example, a transitory computer-readable medium may include a propagated data signal with computer-executable program instructions embodied therein, for example, in base band or as part of a carrier wave. Such a propagated signal may take any of a variety of forms, including, but not limited to, electro-magnetic, optical, or any suitable combination thereof. A transitory computer-readable medium may be any computer-readable medium that can contain, store, communicate, propagate, or transport program code for use by or in connection with an instruction execution system, apparatus, or device. Program code embodied in a transitory computer-readable medium may be transmitted using any appropriate medium, including but not limited to wireless, wired, optical fiber cable, radio frequency (RF), etc.

A non-transitory computer-readable medium may be, for example, but not limited to, a tangible electronic, magnetic, optical, electromagnetic, infrared, or semiconductor storage system, apparatus, device, or any suitable combination of the foregoing. More specific examples (a non-exhaustive list) of the non-transitory computer-readable medium would include, but is not limited to, the following: an electrical device having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It will also be understood that one or more computer-executable program instructions for carrying out operations of the present invention may include object-oriented, scripted, and/or unscripted programming languages, such as, for example, Java, Perl, Smalltalk, C++, SAS, SQL, Python, Objective C, and/or the like. In some embodiments of the invention, the one or more computer-executable program instructions for carrying out operations of embodiments of the present invention are written in conventional procedural programming languages, such as the “C” programming languages and/or similar programming languages. The computer program instructions may alternatively or additionally be written in one or more multi-paradigm programming languages, such as, for example, F#.

The computer-executable program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention may take the form of an entirely hardware embodiment of the invention, an entirely software embodiment (including firmware, resident software, micro-code, etc.), or an embodiment combining software and hardware aspects that may generally be referred to herein as a “module,” “application,” or “system.”

It should be understood that terms like “bank,” “financial institution,” and “institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, and/or the like. Additionally, disclosed embodiments may suggest or illustrate the use of agencies or contractors external to the financial institution to perform some of the calculations, data delivery services, and/or authentication services. These illustrations are examples only, and an institution or business can implement the entire invention on their own computer systems or even a single work station if appropriate databases are present and can be accessed.

The terminology used herein is for the purpose of describing particular embodiments only and is not intended to be limiting of the invention unless the context clearly indicates otherwise. As used herein, the singular forms “a,” “an,” and “the” are intended to include the plural forms as well, unless the context clearly indicates otherwise. It will be further understood that the terms “includes,” “has,” “comprises,” “including,” having,” and/or “comprising,” when used in this specification, specify the presence of stated features, integers, steps, operations, elements, and/or components in the stated embodiment of the invention, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

1. A computer-implemented method of managing data on a mobile device, the method comprising:
receiving data from a user, wherein the data is associated with a first mobile device;
updating the data based on a trigger from the first mobile device, wherein the trigger is a predetermined level of change in the first mobile device;
establishing more than one profile for the user based on changes on the first mobile device;
receiving a request from the user to communicate the data to the first mobile device or a second mobile device;
identifying, using a computing device processor, the data associated with the user; and
communicating the data to the first mobile device or to the second mobile device.

2. The computer-implemented method of claim 1, further comprising:
determining the operating system of the second mobile device; and
modifying, using a computing device processor, the data to load onto the operating system of the second mobile device.

3. The computer-implemented method of claim 1, further comprising periodically updating the data.

4. (canceled)

5. The computer-implemented method of claim 1, further comprising augmenting, via a computing device processor, the data for the first mobile device or the second mobile device based on the data received from the user.

6. The computer-implemented method of claim 5, wherein augmenting the data further comprises analyzing, via a computing device processor, the data received from the user, and determining an offer to provide to the user based on the analysis.

7. (canceled)

8. The computer-implemented method of claim 1, wherein the profiles are established automatically based on use of the first mobile device during specific times.

9. The computer-implemented method of claim 8, wherein a business profile is established based on use of the first mobile device during a first time period and wherein a personal profile is established based on use of the first mobile device during a second time period.

10. The computer-implemented method of claim 1, further comprising establishing a time stamp profile, wherein the user can load the time stamp profile on the first mobile device to reload a previous setting on the first mobile device.

11. A system for managing data on a mobile device, the system comprising:
a computing platform including a processor and a memory;
a data routine stored in the memory, executable by the processor and configured to receive data from a user, wherein the data is associated with a first mobile device;
a financial institution database stored in the memory and configured to store data associated with the first mobile device at the request of the user;
an identification routine stored in the memory, executable by the processor and configured to identify the data associated with the user in response to the request of the user;
an updating routine stored in the memory, executable by the processor, and configured to update the data based on a trigger from the first mobile device, wherein the trigger is a predetermined level of change in the first mobile device;
a profile routine stored in the memory, executable by the processor, and configured to establish more than one profile for the user based on changes on the first mobile device; and
a communication routine stored in the memory, executable by the processor and configured to communicate the data to the first mobile device or to a second mobile device.

12. The system of claim 11, further comprising an operating system routine stored in the memory, executable by the processor, and configured to identify the operating system of the second mobile device and modify the data to load onto the operating system of the second mobile device.

13. The system of claim 11, wherein the data routine is configured to periodically receive data from the first mobile device and store the data in the financial institution database.

14. (canceled)

15. The system of claim 11, wherein the profiles are selected from the group consisting of a business profile, a personal profile, a travel profile, a shopping profile, and a high security profile.

16. The system of claim 11, wherein the profile is determined based on the location of the user, wherein the location of the user is determined based on a geographic positioning device.

17. The system of claim 11, further comprising an augmentation routine stored in the memory, executable by the processor, and configured to augment the data that is communicated to the first mobile device or the second mobile device.

18. The system of claim 17, wherein the data is augmented with offers that are determined to be of interest to the user based on the data received from the user.

19. The system of claim 17, wherein the data is augmented with information, wherein the information is determined from a social networking site.

20. A computer program product for managing data on a mobile device, the computer program product comprising:
a non-transitory computer-readable medium comprising:
a set of codes for causing a computer to receive data from a user, wherein the data is associated with a first mobile device;
a set of codes for causing a computer to update the data based on a trigger from the first mobile device, wherein the trigger is a predetermined level of change in the first mobile device;
a set of codes for causing a computer to establish more than one profile for the user based on changes on the first mobile device;
a set of codes for causing a computer to receive a request from the user to communicate the data to the first mobile device or to a second mobile device;
a set of codes for causing a computer to identify the data associated with the user; and
a set of codes for causing a computer to communicate the data to the first mobile device or to a second mobile device.

21. The computer program product of claim 20, wherein the data include settings and files for the first mobile device.

22. The computer program product of claim 20, further comprising a set of codes for causing a computer to augment the data for the user.

23. The computer program product of claim 22, further comprising a set of codes for causing a computer to determine a business that the user has conducted a transaction at previously and a set of codes for causing a computer to augment the data with a coupon for the business.

24. (canceled)

25. The computer program product of claim 20, further comprising a set of codes for causing a computer to determine the operating system of the second mobile device and modify the data for loading onto the operating system of the second mobile device.

26. The computer program product of claim 20, wherein the data includes a mobile wallet application.

27. The computer program product of claim 20, wherein the computer identifies the data associated with the user based on an account of the user.

28. The computer program product of claim 20, wherein the data is communicated to the first mobile device or to the second mobile device in a compressed format.
